(19) United States
(12) Patent Application Publication
(10) Pub. No.: US 2018/0150907 A1
(43) Pub. Date: May 31, 2018

(54) SYSTEM AND METHOD FOR DETERMINING BEST VENUE FOR SELLING A VEHICLE

(71) Applicant: KAR Auction Services, Inc., Carmel, IN (US)

(72) Inventors: Huey Wayne Antley, San Diego, CA (US); Patrick Walsh, Carmel, IN (US)

(73) Assignee: KAR Auction Services, Inc., Carmel, IN (US)

(21) Appl. No.: 15/365,218

(22) Filed: Nov. 30, 2016

(51) Int. Cl. G06Q 30/08; G06Q 30/02

(52) U.S. Cl. CPC G06Q 30/08; G06Q 30/0202

(57) ABSTRACT

A venue recommendation and alert system is disclosed for receiving vehicle attribute information, analyzing the vehicle attribute information, determining a recommended venue for listing the vehicle, presenting the recommended venue to a user, and alerting the user of any changes to the recommendation based on new information.

### BACKGROUND

A vehicle, through its useful lifetime, may be sold multiple times. For example, the owner may determine to sell the vehicle, and select the venue for the sale. Currently, there are multiple options in which to sell the vehicle, including via a dealer, via a live auction, via an online auction, etc. In this regard, the owner may select, from the multiple options available, the best option to sell the vehicle.

### DESCRIPTION OF THE FIGURES

FIG. 1 illustrates an exemplary venue recommendation and alert system.

FIG. 2 illustrates a block diagram of an exemplary computer architecture for a device in the exemplary venue recommendation and alert system of FIG. 1.

FIG. 3 illustrates an exemplary flow diagram of logic that components of the venue recommendation and alert system of FIG. 1 may implement.

FIG. 4 illustrates an exemplary graphical interface of the venue recommendation and alert system.

FIG. 5 illustrates an exemplary flow diagram of logic that components of the venue recommendation and alert system of FIG. 1 may implement.

### DETAILED DESCRIPTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

As discussed in the background, a vehicle owner may be presented with multiple venues in which to sell the vehicle. In order to select a best venue, from amongst the multiple venues available, a method and system are disclosed. The method and system may input vehicle information, and may generate one or more graphical user interfaces (GUIs) for presenting to the vehicle owner. Further, the method and system may generate one or more alerts responsive to the best venue determination.

In one example, the method and system for selecting the best venue may use a web-based application. In particular, given the increasing level of connectivity between users communicating through communication networks, there has been an increased interest and benefit to developing web-based applications. The web-based application is generally understood to be an application stored and configured to operate, at least in part, on a web server accessible to other communication devices connected to a common network. A user operating their communication device may communicate with the web-server through the common network to access and operate the web-based application. Because its framework is stored on one or more web servers, the web-based application allows for accessibility to remote users, other computers, and databases within the network.

Further, the web-based application is configured to generate unique graphical interfaces for presenting information to users on their personal communication devices, where the data processing for creating the information was processed, at least in part, by an off-site server computer. This system arrangement frees the user's personal communication device from including the additional computing hardware for processing complex information, as the data processing is accomplished, at least in part, by the off-site server computer. This in turn may allow the user's communication device to be manufactured with less components (may translate to decreasing the physical dimensions of the communication device), and/or components having decreased capabilities (may translate to decreasing cost of manufacturing). Alternatively, the user's personal communication device, freed from generating the unique graphical interfaces, may perform other processing.

The web-based application may also be configured to create and send unique alerts to users through networks (e.g., the Internet).

Different situations may trigger a scenario where a vehicle is offered for sale. Exemplary scenarios include, but are not limited to: repossession of the vehicle; sale of the vehicle after a lease term ends; or a dealer offering the vehicle for sale after the vehicle did not sell at the dealership. When deciding to sell, there are multiple different venues available in which to sell a vehicle. For example, a vehicle may be sold via different auction operators, such as Insurance Auto Auctions (IAA) or ADESA. Each specific auction operator may have multiple auction locations where vehicles may be sold. Within this context, a vehicle owner or seller may wish to know which venue will provide the owner/seller the greatest benefit, which may be based on one or more factors. As discussed in more detail below, example factors include, but are not limited to: best return (e.g., highest selling price); transportation cost (e.g., location of auction site); timeliness of sale (e.g., how soon the auction may be held); etc. These factors are provided for illustrative purposes, as other factors are also contemplated.

To fully utilize the technical advantages of a communication network, a venue recommendation and alert system is disclosed for receiving vehicle attribute information, analyzing the vehicle attribute information, determining a recommended venue for listing the vehicle, presenting the recommended venue to a user, and alerting the user of any changes to the recommendation based on new information.

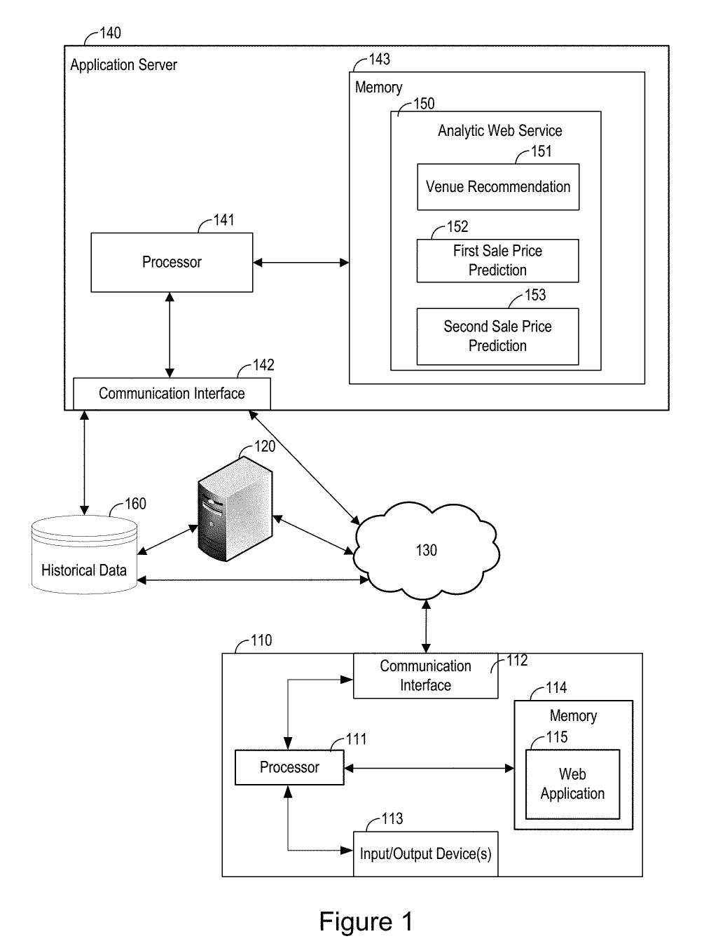

FIG. 1 illustrates an exemplary venue recommendation and alert system 100 (the “system”) that includes component devices for implementing the described features. The system 100 includes an application server 140 configured to include the hardware, software, and/or middleware for operating an analytic web service 150. Application server 140 is shown to include a processor 141, a memory 143, and a communication interface 142.

Analytic web service 150 may be a representation of software, hardware, and/or middleware configured to implement features of the analytic web service 150, such as determining a recommended venue for selling the user's vehicle, revising the recommended venue based on updated information, and alerting the user of changes to the recommendation. For example, the analytic web service 150 may be a web-based application operating, for example, according to a .NET framework within the system 100. More specifically, the analytic web service 150 may include venue recommendation circuitry 151, first sale price prediction circuitry 152 (e.g., for predicting sale of vehicle at a first auction venue such as IAA), and second sale price prediction circuitry 153 (e.g., for predicting sale of vehicle at a second auction venue such as ADESA). Each of the venue recommendation circuitry 151, first sale price prediction circuitry 152, and second sale price prediction circuitry 153 may be a representation of software, hardware, and/or middleware configured to implement respective features of the analytic web service 150.

The system 100 further includes a database 160 for storing historical data describing past vehicle sales at different venues that are part of a vehicle selling venue network accessible by the analytic web service 150. The application server 140 may communicate with the database 160 directly to access the historical vehicle sales information. The application server 140 may also communicate with the database 160 through a venue server 120 via network 130, such as the Internet, where the venue server 120 is in communication with the database 160. The venue server 120 may be controlled by a venue for selling vehicles that is part of the vehicle network associated with the analytic web service.

The application server 140 communicates with any number and type of communication devices via network 130. The communication device 110 shown in FIG. 1 may include well known computing systems, environments, and/or configurations that may be suitable for implementing features of the analytic web service 150 such as, but are not limited to, smart phones, tablet computers, personal computers (PCs), server computers, handheld or laptop devices, multiprocessor systems, microprocessor-based systems, network PCs, server computers, minicomputers, mainframe computers, embedded systems, distributed computing environments that include any of the above systems or devices, and the like. FIG. 1 further shows that the communication device 110 includes a processor 111, a memory 114 configured to store the instructions for operating a web application 115 (web application 115 may be part of analytic web service 150), an input/output devices 113, and a communication interface 112. A user operating the communication device 110 may run the web application 115 to access the analytic web service 150 running on the application server 140.

A process for determining a recommended venue may begin with an input of vehicle attribute information to the web application 115 running on the user's communication device 110. The user may be a lender interested in repossession of the vehicle, or a lease holder interested in learning about a predicted vehicle sales price in anticipation of the vehicle's lease ending. Alternatively, the process may begin responsive to accessing memory 143 in application server 140. The vehicle attribute information may include year, make, model, photos, vehicle condition information (e.g., damage assessment) and/or location of the vehicle. In some embodiments, the web application 115 may implement image analysis on photos included in the vehicle attribute information to identify damage visible on the vehicle, and generate vehicle condition information identifying the damage assessment.

Responsive to the input, the web application 115 may control the communication interface 112 of communication device 110 to transmit, via network 130, the vehicle attribute information to the analytic web service 150 running on the application server 140. Once the vehicle attribute information is received through communication interface 142, the analytic web service 150 may access the venue recommendation circuitry 151, which in turn accesses the first sale price prediction circuitry 152, the second sale price prediction circuitry 153, or both. For example, the first sale price prediction circuitry 152 may determine a predicted sales price for the vehicle sold at one or more venue locations for a first vehicle sales venue such as the IAA, based on the received vehicle attribute information. The second sale price prediction circuitry 153 may determine a predicted sales price for the vehicle sold at one or more venue locations for a second vehicle sales venue such as the ADESA, based on the received vehicle attribute information. The first sale price prediction circuitry 152 and second sale price prediction circuitry 153 may apply a variety of weighted factors when determining the predicted sales price for the vehicle at the different venue locations, under the different vehicle auction houses. The venue recommendation circuitry 151 may generate an ordered list of recommended venues, arranged in order of a predicted sales price of the vehicle.

After generating the ordered list, the venue recommendation circuitry 151 may filter the ordered list in view of a set of rules. For example, a general rule set (e.g., consider vehicle auction venue locations less than 200 miles from current vehicle location) may be used to initially filter the ordered list. A customer specific rule set of rules (e.g., consider vehicle auction venue locations less than 30 miles from current vehicle location) may thereafter be used to further filter out the ordered list. The filtered ordered list may then be transmitted back to the user's communication device 110 for presentation to the user. Alternatively, according to some embodiments the ordered list may be transmitted to the user's communication device 110 before the venue recommendation circuitry 151 applies the set of rules. In such embodiments, the web application 115 may apply the set of rules to filter the ordered list.

Once received on the communication device 110, the ordered list may be presented to the user through a graphical user interface (GUI) displayed on a display of the communication device 110. The communication device 110 may also accept user inputs for selecting one or more venue from the ordered list displayed on the GUI. The user's input may override a default recommended venue, which may then be analyzed to update the organized list into a new order.

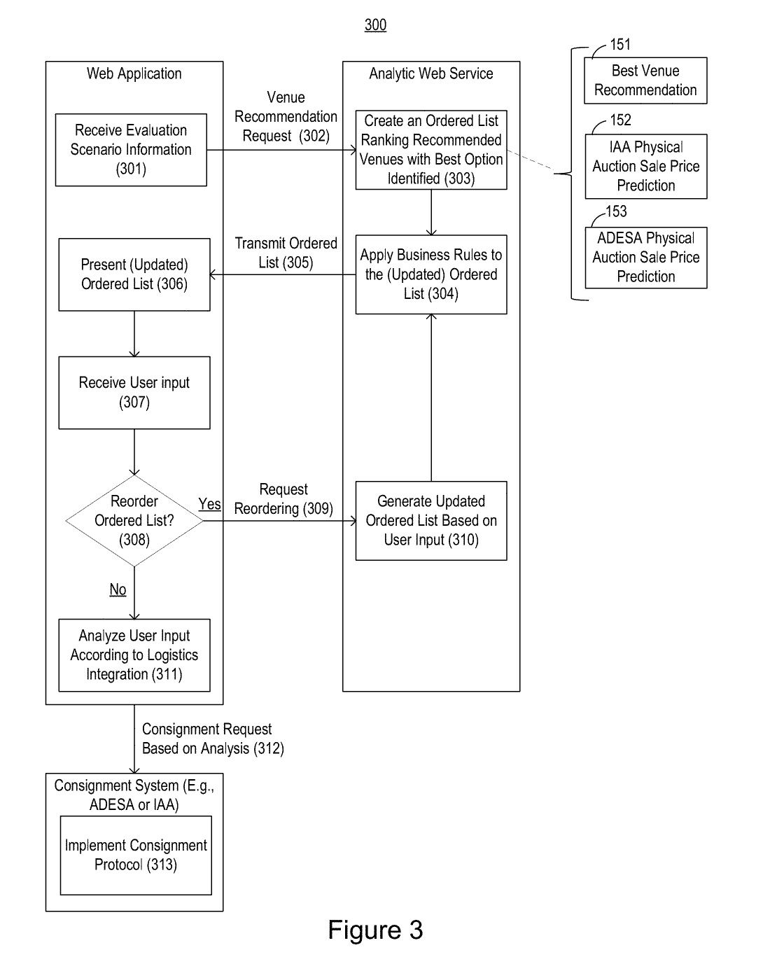

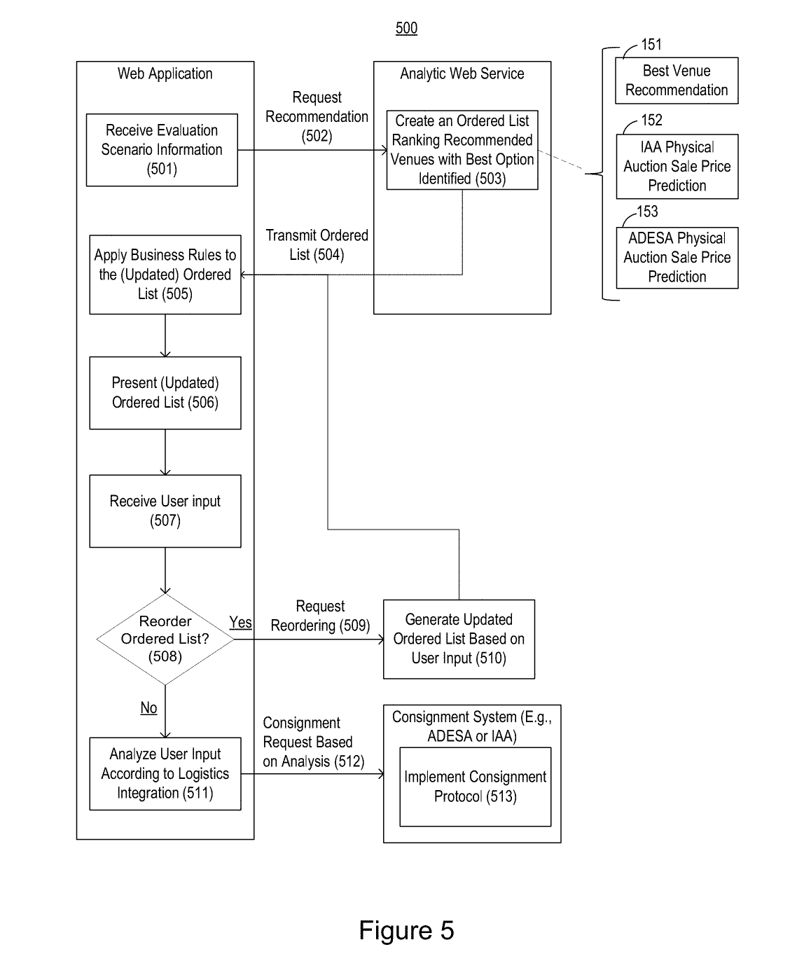

The logic utilized by the analytic web service 150 running on the application server 140 and the web application 115 is described in further detailed with regards to flow diagram 300 illustrated in FIG. 3 and flow diagram 500 illustrated in FIG. 5.

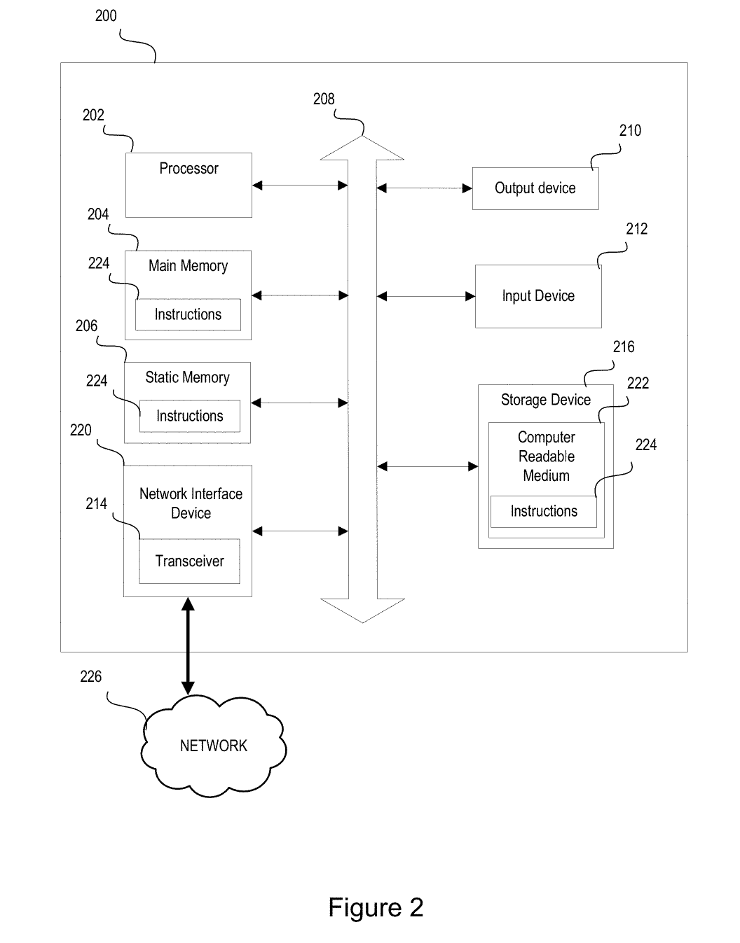

Each of communication device 110, venue server 120, application server 140, and database 160 may include one or more components of computer system 200 illustrated in FIG. 2.

FIG. 2 illustrates exemplary computer architecture for computer system 200. Computer system 200 includes a network interface 220 that allows communication with other computers via a network 226, where network 226 may be represented by network 130 in FIG. 1. Network 226 may be any suitable network and may support any appropriate protocol suitable for communication to computer system 200. In an embodiment, network 226 may support wireless communications. In another embodiment, network 226 may support hard-wired communications, such as a telephone line or cable. In another embodiment, network 226 may support the Ethernet IEEE (Institute of Electrical and Electronics Engineers) 802.3x specification. In another embodiment, network 226 may be the Internet and may support IP (Internet Protocol). In another embodiment, network 226 may be a LAN or a WAN. In another embodiment, network 226 may be a hotspot service provider network. In another embodiment, network 226 may be an intranet. In another embodiment, network 226 may be a GPRS (General Packet Radio Service) network. In another embodiment, network 226 may be any appropriate cellular data network or cell-based radio network technology. In another embodiment, network 226 may be an IEEE 802.11 wireless network. In still another embodiment, network 226 may be any suitable network or combination of networks. Although one network 226 is shown in FIG. 2, network 226 may be representative of any number of networks (of the same or different types) that may be utilized.

The computer system 200 may also include a processor 202, a main memory 204, a static memory 206, an output device 210 (e.g., a display or speaker), an input device 212, and a storage device 216, communicating via a bus 208.

Processor 202 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. Processor 202 executes instructions 224 stored on one or more of the main memory 204, static memory 206, or storage device 215. Processor 202 may also include portions of the computer system 200 that control the operation of the entire computer system 200. Processor 202 may also represent a controller that organizes data and program storage in memory and transfers data and other information between the various parts of the computer system 200.

Processor 202 is configured to receive input data and/or user commands through input device 212. Input device 212 may be a keyboard, mouse or other pointing device, trackball, scroll, button, touchpad, touch screen, keypad, microphone, speech recognition device, video recognition device, accelerometer, gyroscope, global positioning system (GPS) transceiver, or any other appropriate mechanism for the user to input data to computer system 200 and control operation of computer system 200 and/or operation of the analytic web service 150. Input device 212 as illustrated in FIG. 2 may be representative of any number and type of input devices.

Processor 202 may also communicate with other computer systems via network 226 to receive instructions 224, where processor 202 may control the storage of such instructions 224 into any one or more of the main memory 204 (e.g., random access memory (RAM)), static memory 206 (e.g., read only memory (ROM)), or the storage device 216. Processor 202 may then read and execute instructions 224 from any one or more of the main memory 204, static memory 206, or storage device 216. The instructions 224 may also be stored onto any one or more of the main memory 204, static memory 206, or storage device 216 through other sources. The instructions 224 may correspond to, for example, instructions that make up the analytic web service 150 or web application 115 illustrated in FIG. 1.

Although computer system 200 is represented in FIG. 2 as a single processor 202 and a single bus 208, the disclosed embodiments applies equally to computer systems that may have multiple processors and to computer systems that may have multiple busses with some or all performing different functions in different ways.

Storage device 216 represents one or more mechanisms for storing data. For example, storage device 216 may include a computer readable medium 222 such as read-only memory (ROM), RAM, non-volatile storage media, optical storage media, flash memory devices, and/or other machine-readable media. In other embodiments, any appropriate type of storage device may be used. Although only one storage device 216 is shown, multiple storage devices and multiple types of storage devices may be present. Further, although computer system 200 is drawn to contain the storage device 216, it may be distributed across other computer systems that are in communication with computer system 200, such as a server in communication with computer system 200. For example, when computer system 200 is representative of communication device 110, storage device 216 may be distributed across to application server 140 when communication device 110 is in communication with application server 140 during operation of the analytic web service 150 and/or web application 115.

Storage device 216 may include a controller (not shown) and a computer readable medium 222 having instructions 224 capable of being executed by processor 202 to carry out functions of the analytic web service 150 and/or web application 115. In another embodiment, some or all of the functions are carried out via hardware in lieu of a processor-based system. In one embodiment, the controller included in storage device 216 is a web application browser, but in other embodiments the controller may be a database system, a file system, an electronic mail system, a media manager, an image manager, or may include any other functions capable of accessing data items. Storage device 216 may also contain additional software and data (not shown), for implementing described features.

Output device 210 is configured to present information to the user. For example, output device 210 may be a display such as a liquid crystal display (LCD), a gas or plasma-based flat-panel display, or a traditional cathode-ray tube (CRT) display or other well-known type of display in the art of computer hardware. Accordingly, in some embodiments output device 210 displays a user interface. In other embodiments, output device 210 may be a speaker configured to output audible information to the user. In still other embodiments, any combination of output devices may be represented by the output device 210.

Network interface 220 provides the computer system 200 with connectivity to the network 226 through any compatible communications protocol. Network interface 220 sends and/or receives data from the network 226 via a wireless or wired transceiver 214. Transceiver 214 may be a cellular frequency, radio frequency (RF), infrared (IR) or any of a number of known wireless or wired transmission systems capable of communicating with network 226 or other computer device having some or all of the features of computer system 200. Bus 208 may represent one or more busses, e.g., USB, PCI, ISA (Industry Standard Architecture), X-Bus, EISA (Extended Industry Standard Architecture), or any other appropriate bus and/or bridge (also called a bus controller). Network interface 220 as illustrated in FIG. 2 may be representative of a single network interface card configured to communicate with one or more different data sources.

Computer system 200 may be implemented using any suitable hardware and/or software, such as a personal computer or other electronic computing device. In addition, computer system 200 may also be a portable computer, laptop, tablet or notebook computer, PDA, pocket computer, appliance, telephone, server computer device, or mainframe computer.

FIG. 3 illustrates an exemplary flow diagram 300 describing components of the analytic web service 150 operating on a server side device (e.g., operating on application server 140), and components of the web application 115 on a client side device (e.g., operating on communication device 110) in communication with the server side device within, for example, the system 100. The features described with relation to the flow diagram 300 correspond to the determination of a recommended venue by the analytic web service 150, as well as processes for updating the recommendation based on user inputs. During the description of the flow diagram 300, references are made to components of system 100 illustrated in FIG. 1 for exemplary purposes.

On the client side operations, web application 115 may be running on, for example, at least portions of communication device 110. For example, instructions comprising the web application 115 may be stored on memory 114, and the instructions comprising the web application 115 may be executed by processor 111. Inputs may be received through an input component of input/output device 113, and information may be presented to the user on an output component of the input/output device 113.

On the server side operations, the analytic web service 150 may be running on, for example, at least portions of the application server 140, venue server 120, and/or the database 160. For example, instructions comprising the analytic web service 150 may be stored on memory 143, and the instructions comprising the analytic web service 150 may be executed by processor 141. The analytic web service 150 may also control the communication interface 142 to access historical vehicle sales information from the database 160 either directly, or though venue server 120 via network 130.

A user operating communication device 110 may input vehicle attribute information into the communication device 110, which will be received by the web application 115 (301).

After receiving the vehicle attribute information, the web application 115 may control, for example, communication interface 112 to transmit a venue recommendation request to the application server 140 (302). The venue recommendation request may include the vehicle attribute information, user identification information, identification information for the communication device 110, and/or location information of the communication device 110.

The application server 140 may receive the venue recommendation request from the communication device 110 through the communication interface 142. The venue recommendation request may then be forwarded to the analytic web service 150, under control of the processor 141. After receiving the venue recommendation request, the analytic web service 150 may create an ordered list that ranks recommended vehicle selling venues (303). In particular, the analytic web service 150 may utilize the first sale price prediction circuitry 152 to determine a predicted price for the vehicle at one or more locations under a first vehicle selling venue (e.g., vehicle auction house). The analytic web service 150 may further utilize the second sale price prediction circuitry 153 to determine a predicted price for the vehicle at one or more locations under a second vehicle selling venue (e.g., vehicle auction house). In determining the predicted sales price for the vehicle under the first vehicle selling venue and the second vehicle selling venue, each of the first sale price prediction circuitry 152 and the second sale price prediction circuitry 153 may access database 160 to receive historical sales information related to the vehicle. The first sale price prediction circuitry 152 may access historical sales information for vehicles previously sold at locations of the first vehicle selling venue that share similar, or same, attributes as the vehicle to determine price predictions for the vehicle being sold at different location under the first vehicle selling venue. The second sale price prediction circuitry 153 may access historical sales information for vehicles previously sold at locations of the second vehicle selling venue that share similar, or same, attributes as the vehicle to determine price predictions for the vehicle being sold at different location under the second vehicle selling venue. The historical sales information may be referenced by the first sale price prediction circuitry 152 and/or the second sale price prediction circuitry 153 to input into one or more mathematical models to generate the predictions described herein. A mathematical model may include a combination of one or more of dynamical systems, statistical models, differential equations, or game theoretic models. A mathematical model may describe relationships between the historical sales information (i.e., variables) that the mathematical model receives as an input, and generate predictions accordingly. A mathematical model may utilize neural network(s) to iteratively train itself to generate more accurate predictions based on inputs comprising of the received historical sales information and previous predictions generated by the mathematical model.

After price predictions are determined by the first sale price prediction circuitry 152, the second sale price prediction circuitry 153, and/or any other combination of sale price prediction circuitry available on the application server 140, the venue recommendation circuitry 151 may create the ordered list of venues for selling the vehicle (303). The ordered list may be comprised of one or more listings, where each listing may include, for example, identification for the vehicle, one or more predicted prices for the vehicle at one or more different locations under the first vehicle selling venue, one or more predicted prices for the vehicle at one or more different locations under the second vehicle selling venue, and an identification of a best venue. The best venue may be tagged, flagged, highlighted, or otherwise identified as the best venue when displayed within a GUI.

The ordered list may be ordered by highest predicted sales price, to lowest predicted sales price, according to a median (or mean) predicted sales price. The ordered list may be ordered by lowest predicted sales price, to highest predicted sales price, according to a median (or mean) predicted sales price. The ordered list may be separate by vehicle sales venue. For example, the ordered list may be ordered by highest predicted sales price to lowest predicted sales price for the first vehicle sales venue in a first section, then ordered by highest predicted sales price to lowest predicted sales price for the second vehicle sales venue in a second section. The ordered list may be ordered by distance from the user and/or communication device 110 as identified in the venue recommendation request.

After creating the ordered list, one or more business rules may be applied to the ordered list for filtering out (i.e., removing) certain listings that do not pass an applied business rule (304).

After the one or more business rules are applied to the ordered list, the filtered ordered list is transmitted back to the communication device 110 (305).

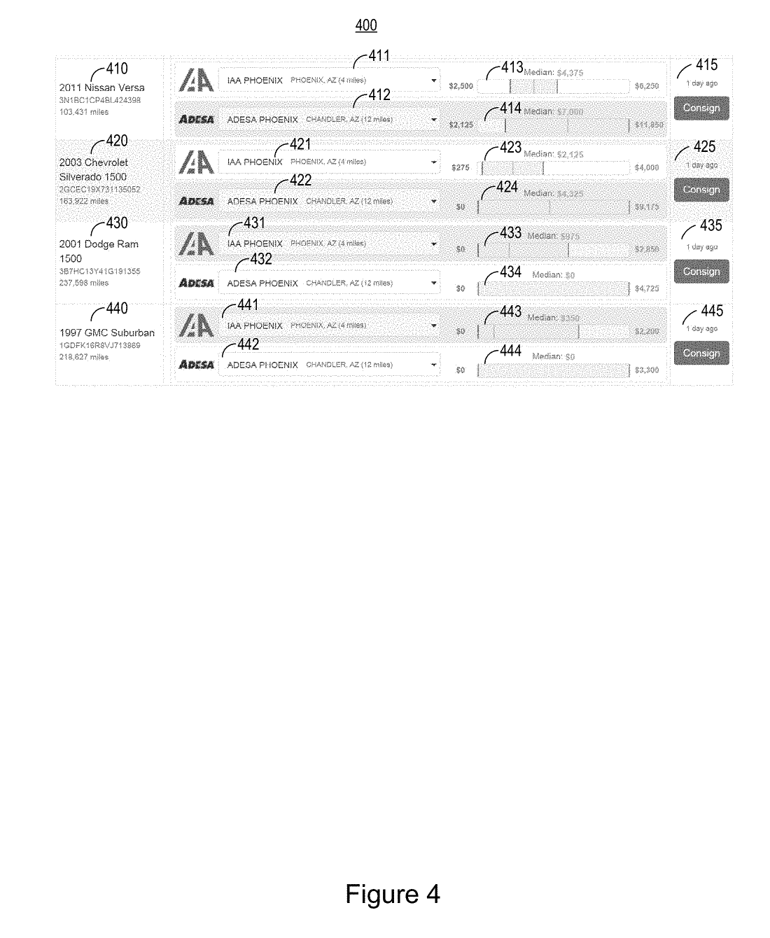

The filtered ordered list may then be presented to the user through a GUI generated by the web application 115 (306). FIG. 4 illustrates an exemplary GUI 400 that may be generated by the web application 115. GUI 400 includes a first listing 410, second listing 420, third listing 430, and a fourth listing 440. First listing 410 identifies a vehicle as a 2011 (model year) Nissan (make) Versa (model) with VIN number 3N1BC1CP4BL424398 and 103,431 miles (odometer reading). First listing 410 further includes a first venue location field 411 identifying a location of a first vehicle selling venue (IAA Phoenix, Ariz.), and a first venue price prediction field 413 identifying a price prediction of the vehicle at the location identified in the first venue location field 411. The first venue location field 411 may include a drop down menu that further displays additional locations of the first venue. When a different location is selected from the first venue location field 411, the price prediction identified in the first venue price prediction field 413 may change to correspond to the selected location. The price prediction identified in the first venue price prediction field 413 reads a median price prediction of $4,375, and having a range of past sales for similar vehicles from $2500 (lowest sale) to $6250 (highest sale).

First listing 410 further includes a second venue location field 412 identifying a location of a second vehicle selling venue (ADESA Phoenix, Ariz.), and a second venue price prediction field 414 identifying a price prediction of the vehicle at the location identified in the second venue location field 412. The second venue location field 412 may include a drop down menu that further displays additional locations of the second venue. When a different location is selected from the second venue location field 412, the price prediction identified in the second venue price prediction field 414 may change to correspond to the selected location. The price prediction identified in the second venue price prediction field 414 reads a median price prediction of $7,000, and having a range of past sales for similar vehicles from $2125 (lowest sale) to $11850 (highest sale).

The first listing 410 also includes a consignment option for placing the vehicle on consignment at either of the first vehicle selling venue or second vehicle selling venue.

The GUI 400 further includes similar pricing predictions for the second listing 420 corresponding to the 2003 Chevrolet Silverado 1500, similar pricing predictions for the third listing 430 corresponding to the 2001 Dodge Ram 1500, similar pricing predictions for the fourth listing 440 corresponding to the 1997 GMC Suburban, and similar pricing predictions for any number of additional vehicle sale listings. For example, the second listing 420 includes its own first venue location field 421, second venue location field 422, first venue price prediction field 423, second venue price prediction field 424, and a consignment option 425. The third listing 430 includes its own first venue location field 431, second venue location field 432, first venue price prediction field 433, second venue price prediction field 434, and a consignment option 435. The fourth listing 440 includes its own first venue location field 441, second venue location field 442, first venue price prediction field 443, second venue price prediction field 444, and a consignment option 445.

A recommended venue may be highlighted by a differentiating color such as the highlighted color of the second venue location field 412 corresponding to the first listing 410, the second venue location field 422 corresponding to the second listing 420, the first venue location field 431 corresponding to the third listing 430, and the first venue location field 441 corresponding to the fourth listing 440.

Referring back to flow diagram 300, a user input may be received through the GUI (307). The user input may correspond to the selection of a different recommended venue location, or the selection of a consignment option, as described above.

Based on the received user input, the web application 115 may determine whether to reorder the ordered list (308). For example, the selection of a different recommended venue location may cause the web application 115 to reorder the ordered list. When the user's input is determined to cause the web application 115 to reorder the ordered list, a request to reorder the ordered list is transmitted to the analytic web service 150 (309).

The request to reorder the ordered list may be received by the analytic web service 150 through the communication interface 142 of application server 140. The analytic web service 150 may then generated an updated ordered list based on the user's input (310).

When the user's input is determined not to cause a reordering of the ordered list, the web application 115 may analyze the user input according to logistics integration (311). For example, when the user's input requests a consignment option at a selected vehicle selling venue, a consignment request is transmitted to the selected vehicle selling venue (312). The consignment request may then be received by the corresponding consignment system, and a consignment protocol may be implemented by the consignment system (313).

FIG. 5 illustrates an exemplary flow diagram 500 describing components of the analytic web service 150 operating on a server side device (e.g., operating on application server 140), and components of the web application 115 on a client side device (e.g., operating on communication device 110) in communication with the server side device within, for example, the system 100. The features described with relation to the flow diagram 500 correspond to the determination of a recommended venue by the analytic web service 150, as well as processes for updating the recommendation based on user inputs. References are made to components illustrated in FIG. 1 during the description of the flow diagram 500 for exemplary purposes.

A user operating communication device 110 may input vehicle attribute information into the communication device 110, which will be received by the web application 115 (501).

After receiving the vehicle attribute information, the web application 115 may control, for example, communication interface 112 to transmit a venue recommendation request to the application server 140 (502). The venue recommendation request may include the vehicle attribute information, user identification information, identification information for the communication device 110, and/or location information of the communication device 110.

The application server 140 may receive the venue recommendation request from the communication device 110 through the communication interface 142. The venue recommendation request may then be forwarded to the analytic web service 150, under control of the processor 141. After receiving the venue recommendation request, the analytic web service 150 may create an ordered list that ranks recommended vehicle selling venues (503). In particular, the analytic web service 150 may utilize the first sale price prediction circuitry 152 to determine a predicted price for the vehicle at one or more locations under a first vehicle selling venue (e.g., vehicle auction house). The analytic web service 150 may further utilize the second sale price prediction circuitry 153 to determine a predicted price for the vehicle at one or more locations under a second vehicle selling venue (e.g., vehicle auction house). In determining the predicted sales price for the vehicle under the first vehicle selling venue and the second vehicle selling venue, each of the first sale price prediction circuitry 152 and the second sale price prediction circuitry 153 may access database 160 to receive historical sales information related to the vehicle. The first sale price prediction circuitry 152 may access historical sales information for vehicles previously sold at locations of the first vehicle selling venue that share similar, or same, attributes as the vehicle to determine price predictions for the vehicle being sold at different location under the first vehicle selling venue. The second sale price prediction circuitry 153 may access historical sales information for vehicles previously sold at locations of the second vehicle selling venue that share similar, or same, attributes as the vehicle to determine price predictions for the vehicle being sold at different location under the second vehicle selling venue.

After price predictions are determined by the first sale price prediction circuitry 152, the second sale price prediction circuitry 153, and/or any other combination of sale price prediction circuitry available on the application server 140, the venue recommendation circuitry 151 may create the ordered list of venues for selling the vehicle (503). The ordered list may be comprised of one or more listings, where each listing may include, for example, identification for the vehicle, one or more predicted prices for the vehicle at one or more different locations under the first vehicle selling venue, one or more predicted prices for the vehicle at one or more different locations under the second vehicle selling venue, and an identification of a best venue. The best venue may be tagged, flagged, highlighted, or otherwise identified as the best venue when displayed within a GUI.

The ordered list may be ordered by highest predicted sales price, to lowest predicted sales price, according to a median (or mean) predicted sales price. The ordered list may be ordered by lowest predicted sales price, to highest predicted sales price, according to a median (or mean) predicted sales price. The ordered list may be separate by vehicle sales venue. For example, the ordered list may be ordered by highest predicted sales price to lowest predicted sales price for the first vehicle sales venue in a first section, then ordered by highest predicted sales price to lowest predicted sales price for the second vehicle sales venue in a second section. The ordered list may be ordered by distance from the user and/or communication device 110 as identified in the venue recommendation request.

After creating the ordered list, the ordered list may be transmitted back to the web application 115 (504).

Once received, the web application 115 may apply one or more business rules to the ordered list for filtering out (i.e., removing) certain listings that do not pass an applied business rule (505).

The filtered ordered list may then be presented to the user through a GUI generated by the web application 115 (506). FIG. 4 illustrates an exemplary GUI 400 that may be generated by the web application 115.

A user input may be received through the GUI (507). The user input may correspond to the selection of a different recommended venue location, or the selection of a consignment option, as described above.

Based on the received user input, the web application 115 may determine whether to reorder the ordered list (508). For example, the selection of a different recommended venue location may cause the web application 115 to reorder the ordered list. When the user's input is determined to cause the web application 115 to reorder the ordered list, a request to reorder the ordered list is transmitted to the communication device 110, where it is then received by the web application 115 (509).

The web application 115 may then generate an updated ordered list based on the user's input (510).

When the user's input is determined not to cause a reordering of the ordered list, the web application 115 may analyze the user input according to logistics integration (511). For example, when the user's input requests a consignment option at a selected vehicle selling venue, a consignment request is transmitted to the selected vehicle selling venue (512). The consignment request may then be received by the corresponding consignment system, and a consignment protocol may be implemented by the consignment system (513).

The methods, devices, processing, circuitry, and logic described above may be implemented in many different ways and in many different combinations of hardware and software. For example, all or parts of the implementations may be circuitry that includes an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when executed by the circuitry.

What is claimed is:

1. A system, comprising:
a communication interface configured to communicate with one or both of the database and a client device; and
a processor in communication with the database and the communication interface, the processor configured to:
receive, through the communication interface, a request for evaluating a vehicle, the request including vehicle attribute information;
generate a sales price prediction of the vehicle at a plurality of venue locations based on the vehicle attribute information and mathematical models for predicting vehicle sale prices;
determine a preferred venue from the plurality of venue locations based, at least in part, on the sales price prediction;
generate an ordered list of venues including the preferred venue and at least one of the plurality of venue locations;
generate an interface including the ordered list of venues, the preferred venue, and a selection option; and
control display of the interface.

2. The system of claim 1, wherein the vehicle attribute information includes at least one of vehicle model, vehicle year, vehicle make, vehicle condition, vehicle mileage, or vehicle location.

3. The system of claim 1, wherein the sales price prediction predicts sales through a plurality of sales operators.

4. The system of claim 1, wherein the communication interface is further configured to receive a user input corresponding to a selected venue from the ordered list of venues; and
wherein the processor is further configured to:
generate an updated ordered list of venues based on the selected venue, wherein at least one venue is placed a new order in the updated ordered list of venues;
generate an updated interface including the updated ordered list of venues; and
control display of the updated interface.

5. The system of claim 1, wherein the selection option corresponds to a consignment selection option at a selected sales operator.

6. The system of claim 5, wherein the selected sales operator is a vehicle auction house.

7. The system of claim 1, wherein the sales price prediction of the vehicle is a median sales amount calculated using a mathematical model.

8. The system of claim 7, wherein each of the plurality of benchmark vehicles share at least one common vehicle attribute with the vehicle.

9. The system of claim 1, wherein the sales price prediction of the vehicle is a mean sales amount calculated using a mathematical model.

10. The system of claim 9, wherein the mathematical model uses vehicle attributes of the vehicle.

11. The system of claim 1, wherein the processor is further configured to:
monitor historical sales information;
detect when a change in the historical sales information changes the sales price prediction of the vehicle;
generate an alert identifying the change in the sales price prediction of the vehicle; and
control transmission of the alert to the client device, wherein the alert is configured to update the ordered list of venues displayed on the interface.

12. A method for identifying a recommended venue, comprising:
developing mathematical models for predicting a sale price of a vehicle;
receiving, through a communication interface, a request for evaluating the vehicle, the request including vehicle attribute information;
generating a sales price prediction of the vehicle at a plurality of venue locations based on the vehicle attribute information and the mathematical models;
determining a preferred venue from the plurality of venue locations based, at least in part, on the sales price prediction;
generating an ordered list of venues including the preferred venue and at least one of the plurality of venue locations;
generating an interface including the ordered list of venues, the preferred venue, and a selection option; and
controlling display of the interface.

13. The method of claim 12, wherein the vehicle attribute information includes at least one of vehicle model, vehicle year, vehicle make, vehicle condition, vehicle mileage, or vehicle location.

14. The method of claim 12, wherein the sales price prediction predicts sales through a plurality of sales operators.

15. The method of claim 12, further comprising:
receiving a user input corresponding to a selected venue from the ordered list of venues;
generating an updated ordered list of venues based on the selected venue, wherein at least one venue is placed in a new order in the updated ordered list of venues;
generating an updated interface including the updated ordered list of venues; and
controlling display of the updated interface.

16. The method of claim 12, wherein the selection option corresponds to a consignment selection option at a selected sales operator.

17. The method of claim 16, wherein the selected sales operator is a vehicle auction house.

18. The method of claim 12, wherein the sales price prediction of the vehicle is a median sales amount calculated using a mathematical model.

19. The method of claim 12, wherein each of the plurality of benchmark vehicles share at least one common vehicle attribute with the vehicle.

20. The method of claim 12, wherein the sales price prediction of the vehicle is a mean sales amount calculated using a mathematical model.
